(19) United States
(12) Patent Application Publication
(10) Pub. No.: US 2009/0214000 A1
(43) Pub. Date: Aug. 27, 2009

(54) SYSTEM AND METHOD FOR PROVIDING MEDICAL AND CONTACT INFORMATION DURING AN EMERGENCY CALL

(75) Inventors: Subodh Manubhai Patel, Walnut Creek, CA (US); Antoine Porter Brooks, Palo Alto, CA (US)

Correspondence Address: FOLEY & LARDNER LLP, P.O. BOX 80278, SAN DIEGO, CA, 92138-0278, US

(73) Assignee: Medical Envelope L.L.C.

(21) Appl. No.: 12/161,326

(22) PCT Filed: Dec. 28, 2006
(86) PCT No.: PCT/US06/49603

§ 371 Date: Dec. 16, 2008

Related U.S. Application Data
(60) Provisional application No. 60/759,524, filed on Jan. 17, 2006.

(51) Int. Cl. H04M 11/04

(52) U.S. Cl. 379/45

(57) ABSTRACT

A system and method for providing medical and contact information of a subscriber initiating an emergency 911 call, directly to a response center at the time of the receipt of the emergency 911 call. Upon the initiation of an emergency 911 call, the existing infrastructure equipment of a communication service provider are able to access a central server containing the medical and contact information of a subscriber, and relay that information directly to a response center to speed response time and response effectiveness. Alternatively, an agent resident on a communications device used by a subscriber can store and maintain medical and contact information of the subscriber, as well directly transmit the medical and contact information to the response center. In addition, a subscriber has the ability to access, view, and modify his or her medical and contact information through an appropriate interface allowing interaction with either the central server or the agent.

### FIELD OF THE INVENTION

The present invention relates generally to the field of emergency communications. More specifically, the present invention relates to a communication network and associated method for quickly and easily storing and retrieving information related to the subject of an emergency communication.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Emergency notification systems have been in use for many years, routing emergency calls to proper response authorities such as the local police, fire department, ambulance service, etc., where dialing 9-1-1 denotes that a call is an emergency call. In approximately over 93% of locations in the United States and Canada, dialing 9-1-1 from any telephone will connect a caller to an emergency dispatch center called a Public Safety Answering Point (PSAP), which can send emergency response personnel to the caller's location in an emergency. FIG. 4 shows a typical communications network in which basic 911 service is implemented. A user makes a 911 call using telephone 400 indicating that the user is in some sort of distress. The call is routed to a local exchange carrier (LEC) switch 405 and forwarded to a 911 tandem switch 410. Upon receipt of the 911 call, the 911 tandem switch 410 routes the 911 call to one of a plurality of PSAPs 415a, 415b, or 415c. Alternatively, the LEC switch 405 can route the 911 call directly to one of the PSAPs 415a, 415b, 415c. It should be noted that a PSAP is a designation used to describe a location where the 911 call is terminated, answered, processed, and the nature of the distress or emergency is determined and assessed. An automatic call distributor (ACD), a call center, or a private branch exchange (PBX) switch can function as a PSAP, or PSAP equipment can include an ACD, call center, or PBX switch. An operator (not shown) of PSAP 415b processes the 911 call and forwards it to an appropriate response center or agency, e.g., an ambulance service 420, a local fire department 425, or a local police department 430.

In some areas, enhanced 911 (e911) is available, which automatically gives the PSAP the caller's location, if available. FIG. 5 is an example of a communications network in which e911 service is implemented. The network operates as described with reference to FIG. 4. However, instead of only voice data being sent from telephone 400, Automatic Number Identification (ANI) information is also sent through the communication network. Originally, ANI information was utilized to assist a telephony company in accessing toll charges for long distance calls. Advances in technology, however, allowed ANI information to be used in relaying needed information to a PSAP for 911 response as well. Therefore, upon receipt of a 911 call at the 911 tandem switch 410, the ANI information associated with telephone 400 is read, thereby allowing 911 tandem switch 410 to send the callback number of telephone 400 to the display of a workstation at the appropriate PSAP 415a, 415b, or 415c. With this callback number information, the appropriate PSAP is able to access a 911/Automatic Location Identifier (ALI) database 540 and retrieve the caller's physical address or ALI.

However, when 911 calls are made from mobile telephones, the call may not be routed to the closest PSAP, and the call taker does not receive a callback phone number or the location of the caller. This presents life threatening problems due to lost response time if callers are unable to speak or don't know where they are, or if they don't know their mobile telephone callback number and the call is dropped. The National Emergency Number Association (NENA) is an organization that was created to foster technological advancements, availability, and implementation of a universal emergency telephone number system. To address the problems present in wireless 911, a three phase plan was enacted.

The most basic of these phases, sometimes called Wireless Phase 0, simply provides that when a caller dials 9-1-1 from a wireless telephone, an operator at a PSAP answers. The operator may be at a state highway patrol PSAP, at a city or county PSAP up to hundreds of miles away, or at a local PSAP, depending on how the wireless 911 call is routed.

Wireless Phase I is the first step in providing better emergency response service to wireless 911 callers. When Wireless Phase I has been implemented, a wireless 911 call will come into a PSAP with the mobile telephone callback number. This is important in the event the call is dropped, and may even allow PSAP operators to work with a wireless company to identify the wireless subscriber. However, Wireless Phase I still does not help call takers locate emergency victims or callers.

To locate wireless 911 callers, Wireless Phase II must be implemented in an area by local 911 systems and wireless carriers. Wireless Phase II will allow operators to receive both the caller's mobile telephone number and their location information. This is accomplished by requiring new mobile telephones to provide their latitude and longitude to PSAP emergency response operators in the event of a 911 call. Carriers may choose whether to implement this via GPS chips in each phone, or via triangulation between cell towers. In addition, Wireless Phase II requires carriers to connect 911 calls from any mobile telephone, regardless of whether that phone is currently active. Due to limitations in technology (of the mobile telephone, cell towers, and PSAP equipment), a mobile callers' geographical information may not always be available to the local PSAP.

The networks described above, however, remain very limited in functionality. For example, medical information relating to a caller must still be gleaned by a PSAP operator conversing with the caller. If the caller has become incapacitated or is otherwise unable to speak, the PSAP operator has no way of knowing how best to aid the caller. It is left to emergency response personnel to determine this and act upon arriving at the caller's location. Therefore, it would be helpful to know any pertinent medical information beforehand. It would also be helpful to inform interested parties, such as parents of a child, if the child has initiated a 911 call. There have been attempts to provide medical history information to PSAP operators and systems have been developed to notify third parties of 911 calls. However, these systems and methods require additional infrastructure equipment that are not easy to integrate into existing communication networks. Moreover, these systems and methods still require extra steps of a PSAP operator and extra time, for example, manually accessing and retrieving medical data regarding a 911 caller.

### SUMMARY OF THE INVENTION

Various embodiments of the present invention comprise a system and method for providing medical and contact information associated with a subscriber, to response personnel, such as PSAP operators, local fire and police departments, and the like. This information can include, but is not limited to a subscriber's name, blood type, date of birth, language(s) spoken, and emergency contact(s). When a subscriber initiates an emergency 911 call, an agent in the telephone sends an identifier through the communication network to a central server. The identifier allows the subscriber's associated medical and contact information to be retrieved from the central server, after which the information is relayed to response personnel. In addition, a message can be sent to any contact(s) retrieved in the subscriber's associated medical and contact information at substantially the same time the 911 call is initiated, alerting that contact(s) that a 911 call has been made.

Various embodiments of the present invention allow for better and easier implementation of emergency 911 services. PSAP operators can receive all the necessary information for aiding a subscriber in an emergency immediately without having to manually access outside data sources. Existing service providers do not have to invest in additional infrastructure, nor do service providers have to modify their respective system architectures. Moreover, allowing subscriber's to create and manage their own medical and contact information promotes consumer-driven healthcare objectives, as well as ensures that the most up-to-date information regarding a subscriber is transmitted to response personnel, should the subscriber find him or herself in need of emergency attention. Additionally, interested third parties or contacts can immediately be notified if a 911 call is initiated.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used with the implementation of the present invention;

FIG. 3 is a schematic representation of the telephone circuitry of the mobile telephone of FIG. 2;

FIG. 4 is an overview diagram representing the communications between emergency 911 network elements in a basic emergency 911 network;

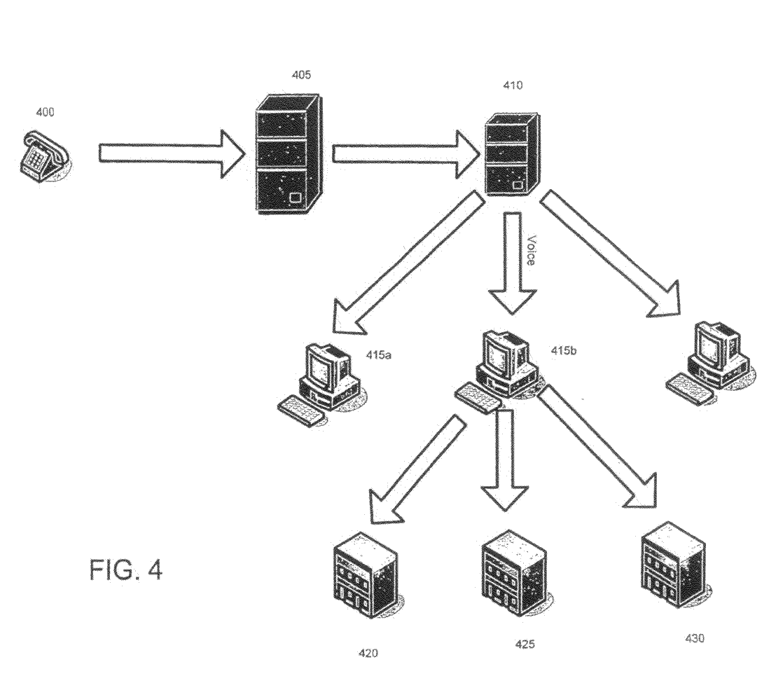

FIG. 5 is an overview diagram representing the communications between emergency 911 network elements in an enhanced emergency 911 network;

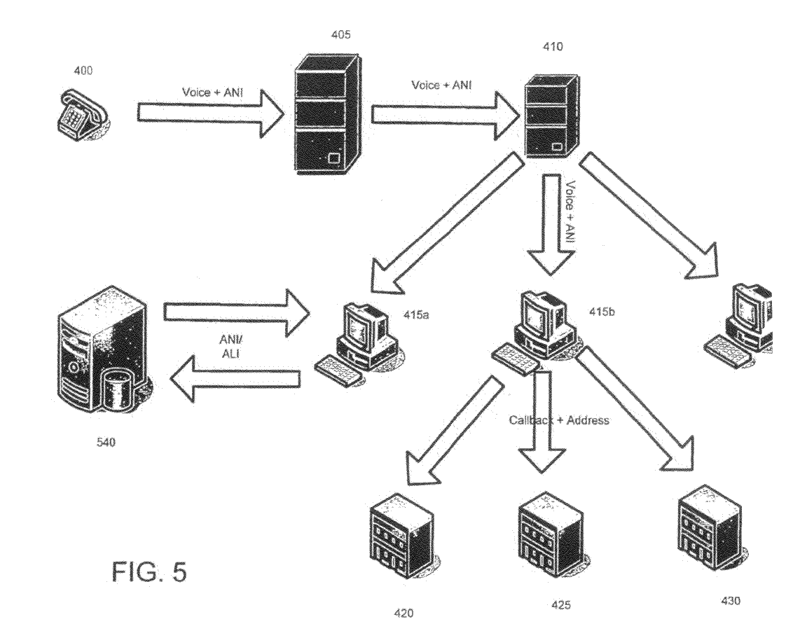

FIG. 6 is an overview diagram representing the communications between emergency 911 network elements in a wireless emergency 911 network;

FIG. 7 is an overview diagram representing the communications between emergency 911 network elements in one embodiment of the present invention;

### DETAILED DESCRIPTION OF THE PREFERRED EMBODIMENTS

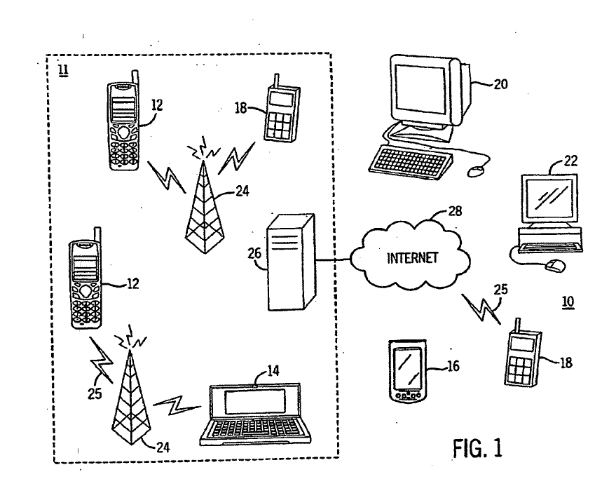

FIG. 1 shows a system 10 in which the present invention can be implemented and utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, i.e., voice over Internet Protocol (VOIP), etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

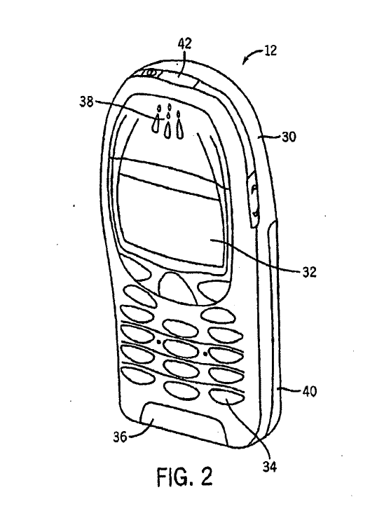

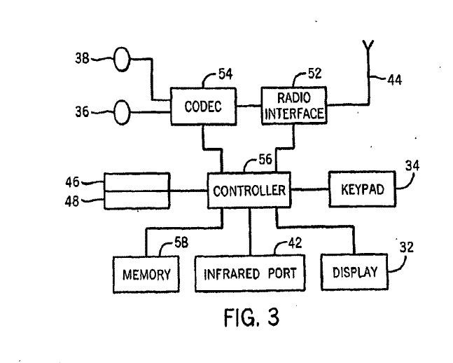

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art.

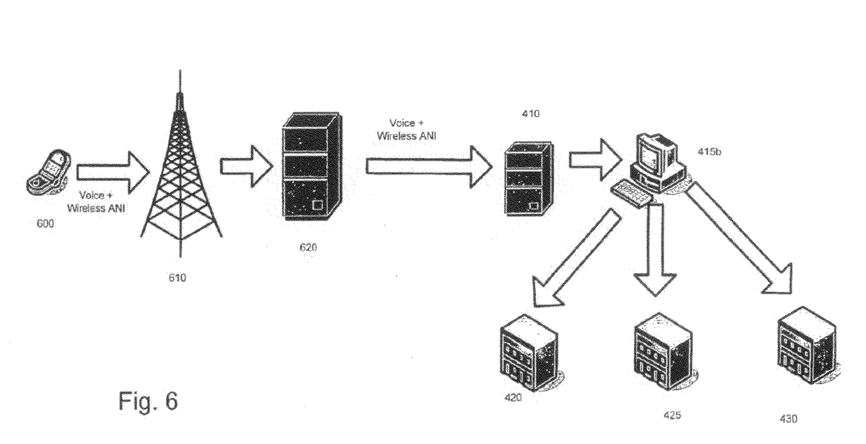

A typical wireless emergency 911 network is shown in FIG. 6. A caller using mobile telephone 600 initiates a wireless 911 call. The nearest serving cell tower 610 picks up the wireless 911 call and relays it to a mobile switching center (MSC) 620. The MSC 620 operates much like a landline LEC switch and forwards the wireless 911 call to 911 tandem switch 410. It should be noted that the MSC 620 is usually a part of or operated by one of a plurality of local wireless service providers. The wireless 911 call is then received at the PSAP 415b, along with wireless ANI data that indicates the wireless telephone callback number of mobile telephone 600. In addition, there are known methods of sending additional ANI-related data with the wireless 911 call, such as information regarding the cell face of the cell tower 610 that received the wireless 911 call, or the cell tower 610 itself. This information can be used to approximate within several hundred square meters, where the wireless 911 call was made from.

As mentioned above, Wireless Phase II promulgated by NENA requires the determination of the location of mobile telephones making 911 calls. One method of accomplishing this is through base station or cell tower triangulation. Each base station or cell tower, for example, cell tower 610, measures the amount of time it takes to receive a mobile telephone's signal when it makes a wireless 911 call. This time data is translated into the distance data, estimating how far the mobile telephone is from the base station or cell tower. This distance data is then cross-referenced with distance data from at least one other base station or cell tower that received the mobile telephone's signal to arrive at longitudinal and latitudinal coordinates for that mobile telephone. Alternatively, the mobile telephone itself can triangulate its location by cross-referencing time-synchronized signals sent from multiple base stations or cell towers. The angle at which a mobile telephone's signal arrives at a base station or cell tower can also be determined using antenna arrays. This angle data can also be cross-referenced with angle data from other base stations or cell towers, and the mobile telephone's location can be triangulated. In addition, many mobile devices are now equipped with global positioning system (GPS) receivers that can receive GPS signals from GPS satellites to determine location.

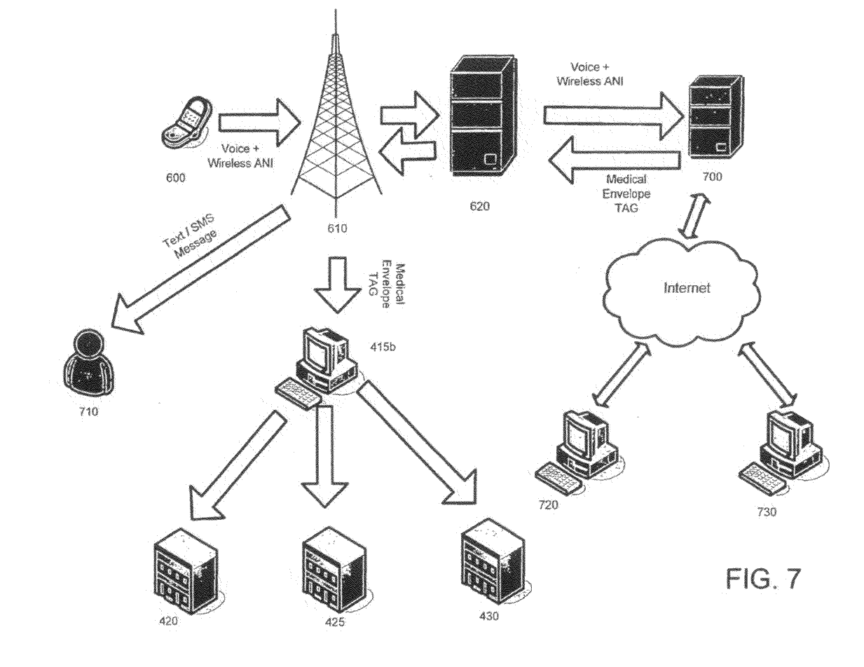

FIG. 7 shows one embodiment of the present invention for providing medical and contact information services to subscribers. The elements of the wireless emergency 911 network of FIG. 6 are utilized in the system architecture of the present invention, with the exception of the 911 tandem switch 410. Replacing the 911 tandem switch 410 is a central server 700. The central server 700 implements and manages all application modules for effecting the medical information service. It should be noted that such an implementation of the present invention requires no infrastructure investment from service providers. Existing wireless networks and service providers, e.g., Verizon, Cingular, T-Mobile, Sprint/Nextel, USCellular, etc. need only install an agent on mobile telephones operating on their respective networks. The agent can be optimized for each service provider or can be coded as a universal application or module, capable of being utilized on any service provider equipment.

The agent for the mobile telephones can be added after being locked to a specific carrier by that service provider, or can be installed by the mobile telephone manufacturer, e.g., Nokia Corporation. Furthermore, the agent can be implemented directly in the mobile telephone itself or on a SIM card/microchip that can be removably installed/inserted into the mobile telephone. The agent is responsible for detecting dual tone multifrequency (DTMF) signals or a dedicated telephone keypad button/softkey representing 9-1-1. If logic in the mobile telephone is not present, the agent can also detect and distinguish between the actual dialing of a 911 call and when the digits 9-1-1 are merely a part of another telephone number or key-pressing sequence. The agent can even be coded to allow a 911 caller to input a unique identifier to identify him or herself in the event he/she must initiate a 911 call from a telephone other than their own, or if a person is initiating the 911 call on behalf of the person in distress. Additionally, a cancellation function can be provided by the agent to prevent false 911 calls from being routed.

Coding the agent can be done using, but not limited to, the Binary Runtime Environment for Wireless (BREW) platform, which is an air-interface independent platform originally used for downloading and running small mobile applications, Java Platform, Micro Edition (J2ME), a collection of Java application programming interfaces (APIs), or another OEM software platform.

In the one embodiment of the present invention, the central server 700 stores and maintains important medical and contact information for subscribers, including, but not limited to, a subscriber's name, date of birth, language(s) spoken, emergency contact(s), blood type, medications, allergies, weight, eye color, driver's license number, living will information, and organ donor information. The medical information services provided by the various embodiments of the present invention can be divided into subscription levels or packages, where all or some subset of the above medical information is stored and maintained for a subscriber. For example, a basic medical information services package can include storing and maintaining a subscriber's name, date of birth, language(s) spoken, emergency contact(s), and blood type. A premium medical information services package can include that information found in the basic service, plus the subscriber's medications, allergies, weight, eye color, driver's license number, living will information, and organ donor information.

In order to store and maintain subscribers' medical and contact information, a management console is provided through which a subscriber can create an emergency health profile. The management console can be a Web-based application/administration tool accessible to subscribers over the Internet or other data network. A subscriber logs onto a website and enters the appropriate medical and contact information into a webpage, after which, the information is loaded into and stored in the central server 700. Alternatively, the website or some other type of user interface, such as an interactive voice recognition (IVR) interface or a simple human operator interface can provide direct access to the central server 700. After creating an emergency health profile, a subscriber can revisit the profile and update or make changes to the information stored therein at his or her discretion. This can be performed using the website or using the subscriber's mobile telephone via the agent resident thereon. This allows a subscriber's relevant medical and contact information to be as up-to-date as possible. Additionally, having personal access to one's medical information promotes consumer-driven healthcare and makes accessing one's medical information an easy task. Third parties, such as insurance companies and hospitals can also be given the authority to access and view or update a subscriber's medical and contact information, or even link their own databases and servers with the central server 700.

When a subscriber initiates a 911 call on his or her mobile telephone 600, the 911 call is routed through the cell tower 610, the MSC 620, and to the central server 700. A service set identifier (SSID), or other identifier capable of identifying the subscriber or the mobile telephone 600, is also sent from the mobile telephone 600 at the same time the 911 call is initiated. Once the subscriber and/or mobile telephone 600 is authenticated using the SSID or other identifier, the central server 700 retrieves the emergency health profile of the calling subscriber. The central server 700 substantially simultaneously instructs the service provider that is operating MSC 620 to send a short message service (SMS) message containing the emergency health profile of the calling subscriber to PSAP 415b, and to send an SMS, text, email, voice, or other type of message(s) to alert any contact(s) stored in the subscriber's emergency health profile to the fact that a 911 call was initiated.

It should be noted that prior to routing the 911 call to the PSAP 415b, the methods discussed above regarding how to determine a mobile telephone's location can be used to choose the nearest PSAP. Alternatively, the agent discussed above, can be further adapted to determine the PSAP nearest to the mobile telephone 600, to which the 911 call should be routed. Geographic areas can be divided into any one of a number of regions, based on various criteria. For example, a specified area of coverage for a PSAP may include an area within the borders of a town or county, whereas in an urban area, the specified area of coverage may be comprised of a predetermined number of blocks. This process of gleaning the relevant medical and contact information before the 911 call reaches a PSAP allows a PSAP operator to have all the necessary information to aid and direct emergency response personnel to the subscriber. In addition, the infrastructure and messaging functionality of existing service providers is better, and more efficiently utilized than in past emergency 911 call systems and architectures.

In another embodiment of the present invention, the agent or the mobile telephone itself can be coded with a subscriber's medical and contact information, bypassing the need to access the control server 700 during the processing of a 911 call. The medical and contact information can be encrypted and password protected as well. This further speeds the process of responding to the 911 call. Additionally, a subscriber can travel anywhere in the world and have access to his or her medical and contact information via his or her mobile telephone. In yet another embodiment of the present invention, the control server 700 as well as routing the emergency 911 call through the MSC 620 or other conventional service provider equipment can be bypassed. This is possible with networks that utilize advanced cell towers that have call routing functionality.

It should be noted that although embodiments of the present invention discussed above are implemented in wireless emergency 911 networks, the present invention is also easily adaptable to landline emergency 911 networks. In addition, various embodiments of the present invention can be utilized on basic as well as e911 networks. The agent can also be installed in other mobile devices, as well as personal computers and voice over IP-based devices, allowing the same functionality discussed above to provided to non-mobile telephone subscribers. In fact, information other than or in addition to medical and contact information can be stored, maintained, and accessed for purposes such as Homeland Security.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for providing subscriber information to a response center upon initiation of a call from a communication device operating on a communication network comprising:
receiving an identifier identifying the communication device;
forwarding the identifier to a switch;
receiving the subscriber information from a central server communicatively connected to the switch upon authentication of the communication device using the identifier;
forwarding the subscriber information to a response center; and
forwarding at least one alert message to at least one contact stored as at least one part of the subscriber information.

2. The method of claim 1, wherein the call is a 911 emergency call.

3. The method of claim 1, wherein the identifier is received from an agent resident on the communication device.

4. The method of claim 1, wherein the subscriber information includes a location of the communication device.

5. The method of claim 1, further comprising forwarding the subscriber information from the response center to at least one public agency located in a specified area, wherein the forwarding occurs substantially simultaneously with the forwarding of the at least one alert message.

6. The method of claim 1, wherein a subscriber is able to access and modify the subscriber information via an interface allowing interaction with the central server.

7. The method of claim 1, wherein the communication network comprises a wireless emergency 911 network

8. The method of claim 1, wherein the communication network comprises a landline emergency 911 network.

9. The method of claim 1, wherein the at least one alert message is an SMS message.

10. The method of claim 1, wherein the subscriber information is at least one type of information selected from a group consisting of name, date of birth, language spoken, emergency contact, blood type, medications, allergies, weight, eye color, driver's license number, living will information, and organ donor information.

11. A method for providing subscriber information in conjunction with a call initiated by a subscriber to a response center comprising:
receiving the call and the subscriber information from a communication device operating on a communication network;
forwarding the call and the subscriber information to the response center; and
forwarding at least one alert message to at least one contact stored as at least one part of the subscriber information.

12. The method of claim 11, wherein the call is a 911 emergency call.

13. The method of claim 11, wherein the subscriber information is stored in an agent resident on the communication device.

14. The method of claim 11, wherein the subscriber information includes a location of the communication device.

15. The method of claim 11, further comprising:
forwarding the subscriber information from the response center to at least one public agency located in a specified area, wherein the forwarding occurs substantially simultaneously with the forwarding of the at least one alert message.

16. The method of claim 11, wherein the subscriber information is at least one type of information selected from a group consisting of name, date of birth, language spoken, emergency contact, blood type, medications, allergies, weight, eye color, driver's license number, living will information, and organ donor information.

17. A computer program product, embodied on a computer-readable medium, for providing subscriber information to a response center upon initiation of a call from a communication device operating on a communication network comprising:
computer code for receiving an identifier identifying the communication device;
computer code for forwarding the identifier to a switch;
computer code for receiving the subscriber information from a central server communicatively connected to the switch upon authentication of the communication device using the identifier;
computer code for forwarding the subscriber information to a response center; and
computer code for forwarding at least one alert message to at least one contact stored as at least one part of the subscriber information.

18. A computer program product, embodied on a computer-readable medium, for providing subscriber information in conjunction with a call initiated by a subscriber to a response center comprising:
computer code for receiving the call and the subscriber information from an agent resident on a communication device operating on a communication network;
computer code for forwarding the call and the subscriber information to the response center; and
computer code for forwarding at least one alert message to at least one contact stored as at least one part of the subscriber information.

19. A communications transceiver comprising:
a processor; and
a memory unit operatively connected to the processor and including:
computer code for receiving an identifier identifying the communication device;
computer code for forwarding the identifier to a switch;
computer code for receiving the subscriber information from a central server communicatively connected to the switch upon authentication of the communication device using the identifier;
computer code for forwarding the subscriber information to a response center; and
computer code for forwarding at least one alert message to at least one contact stored as at least one part of the subscriber information.

20. A communications transceiver comprising:
a processor; and
a memory unit operatively connected to the processor and including:
computer code for receiving the call and the subscriber information from an agent resident on a communication device operating on a communication network;
computer code for forwarding the call and the subscriber information to the response center; and
computer code for forwarding at least one alert message to at least one contact stored as at least one part of the subscriber information.

21. A network architecture for providing subscriber information to a response center upon initiation of a call from a communication device operating on a communication network comprising:
a communications transceiver configured to receive an identifier identifying the communication device;
a switch communicatively connected to the communications transceiver equipment configured to receive the identifier upon forwarding of the identifier by the communications transceiver equipment; and
a central server communicatively connected to the switch configured to transmit the subscriber information through the switch, to the communications transceiver equipment upon authentication by the central server of the communication device using the identifier,
wherein the communications transceiver equipment forwards the subscriber information to a response center and substantially simultaneously forwards at least one alert message to at least one contact stored as at least one part of the subscriber information.

22. A network architecture for providing subscriber information in conjunction with a call initiated by a subscriber to a response center comprising:
a communications transceiver configured to receive the call and the subscriber information from an agent residing on a communication device operating on a communication network, forward the call and the subscriber information to the response center, and substantially simultaneously forward at least one alert message to at least one contact stored as at least one part of the subscriber information.
